(19) United States
(12) Patent Application Publication
(10) Pub. No.: US 2012/0206327 A1
(43) Pub. Date: Aug. 16, 2012

(54) DISPLAY PANEL

(75) Inventor: Chin-Hung Hsu, Taoyuan County (TW)

(73) Assignee: NOVATEK MICROELECTRONICS CORP., Hsinchu (TW)

(21) Appl. No.: 13/450,488

(22) Filed: Apr. 19, 2012

Related U.S. Application Data
(62) Division of application No. 12/478,723, filed on Jun. 4, 2009.

(30) Foreign Application Priority Data
Mar. 24, 2009 (TW) 98109508

(51) Int. Cl. G09G 3/36

(52) U.S. Cl. 345/92

(57) ABSTRACT

A display panel is disclosed has a plurality of source data lines and at least a first and a second gate scan lines and includes at least a first, a second, a third and a fourth display rows. Gates of a plurality of the first and second driving transistors of the first and the second display rows respectively are commonly coupled to the first gate scan line. First sources/drains of the first and the fourth driving transistors are sequentially coupled to odd columns of the source data lines. First sources/drains of the second and the third driving transistors are sequentially coupled to even columns of the source data lines. Gates of a plurality of the third and fourth driving transistors of the third and the fourth display rows respectively are commonly coupled to the second gate scan line.

This application is a Divisional of and claims the priority benefit of U.S. patent application Ser. No. 12/478,723, filed on Jun. 4, 2009, now pending, which claims the priority benefits of Taiwan application Serial No. 98109508, filed Mar. 24, 2009. The entirety of each of the above-mentioned patent applications is hereby incorporated by reference herein and made a part of this specification.

### BACKGROUND OF THE INVENTION

1. Field of the Invention

The present invention relates to a display panel.

2. Description of Related Art

With development of electronic technology, electronic products have become indispensable important tools in people's daily life. Taking a display panel as an example, the conventional simple display panel cannot satisfy utilization requirements of a user. Therefore, display panels having features of high quality, low cost and power-saving become a main stream in the market.

Referring to FIG. 1, FIG. 1 is a schematic diagram illustrating a conventional liquid crystal display (LCD) panel 100. The LCD panel 100 includes a timing generator 110, a source driver 120, a gate driver 130 and a plurality of pixel units 141. The pixel units 141 are encircled by a plurality of source data lines SL and a plurality of gate data lines GL respectively connected to the source driver 120 and the gate driver 130. In the conventional LCD panel 100, since a frame rate is almost fixed, during the scanning, a maximum possible time required for scanning each of the gates has to be calculated according to a gate amount of the LCD panel 100. If an amount of the gate scan lines of the LCD panel is great, the maximum possible time required for scanning each of the gates is relatively reduced. Therefore, after pixel data is transmitted to the pixel unit 141 through the source data line SL, a charge time required for storing the pixel data is probably inadequate.

Therefore, the conventional technique provides a plurality of methods to resolve the above problem of inadequate charge time. For example, a driving voltage is increased to over drive (OD) the pixel unit 141. However, according to such driving method, not only a higher supply voltage has to be applied, but also extra power is consumed, so that requirements of low cost and power-saving cannot be satisfied.

### SUMMARY OF THE INVENTION

The present invention is directed to a display panel, which can effectively increase a charge time for each gate scan line.

The present invention provides a display panel. The display panel has a plurality of source data lines, at least one first gate scan line and at least one second gate scan line. The display panel includes at least one first display row, at least one second display row, at least one third display row and at least one fourth display row. The first display row includes a plurality of first pixel units, and each of the first pixel units includes a first driving transistor. Gates of the first driving transistors are commonly coupled to the first gate scan line. First sources/drains of the first driving transistors are sequentially coupled to odd columns of the source data lines. Moreover, the second display row includes a plurality of second pixel units, and each of the second pixel units includes a second driving transistor. Gates of the second driving transistors are commonly coupled to the first gate scan line. First sources/drains of the second driving transistors are sequentially coupled to even columns of the source data lines. The third display row includes a plurality of third pixel units, and each of the third pixel units includes a third driving transistor. Gates of the third driving transistors are commonly coupled to a second gate scan line. First sources/drains of the third driving transistors are sequentially coupled to even columns of the source data lines. The fourth display row includes a plurality of fourth pixel units, and each of the fourth pixel units includes a fourth driving transistor. Gates of the fourth driving transistors are commonly coupled to the second gate scan line. First sources/drains of the fourth driving transistors are sequentially coupled to odd columns of the source data lines. Moreover, the first, the second, the third and the fourth display rows are sequentially disposed on the display panel.

In an embodiment of the present invention, an amount of the source data lines is a sum of an amount of the first pixel units and an amount of the second pixel units.

In an embodiment of the present invention, each of the first pixel units includes a first liquid crystal capacitor, and the first liquid crystal capacitor is coupled to a second source/drain of the first driving transistor.

In an embodiment of the present invention, each of the second pixel units includes a second liquid crystal capacitor, and the second liquid crystal capacitor is coupled to a second source/drain of the second driving transistor.

In an embodiment of the present invention, the first driving transistors and the second driving transistors are thin-film transistors.

In an embodiment of the present invention, the third driving transistors and the fourth driving transistors are thin-film transistors.

In an embodiment of the present invention, each of the first pixel units further includes a third liquid crystal capacitor coupled to a second source/drain of the third driving transistor.

In an embodiment of the present invention, each of the fourth pixel units further includes a fourth liquid crystal capacitor coupled to a second source/drain of the fourth driving transistor.

In an embodiment of the present invention, the display panel further includes at least one source driver, and the source driver is coupled to the source data lines for transmitting a plurality of pixel data through the source data lines.

In an embodiment of the present invention, the display panel further includes at least one gate driver, and the gate driver is coupled to the first gate scan line for performing a scan operation to the first and the second display row through the first gate scan line.

In the present invention, one gate scan line is connected to two adjacent display rows of the display panel. Therefore, the amount of the gate scan lines is effectively reduced to a half, and when the display panel is scanned, the charge time for each of the gate scan lines is effectively prolonged, so as to improve a display quality of the display panel.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a conventional liquid crystal display (LCD) panel 100.

FIG. 2 is a schematic diagram illustrating a display panel 200 according to an embodiment of the present invention.

FIG. 3 is a diagram of operation waveforms of a display panel 200.

FIG. 4 is a schematic diagram illustrating a display panel 400 according to an embodiment of the present invention.

### DESCRIPTION OF EMBODIMENTS

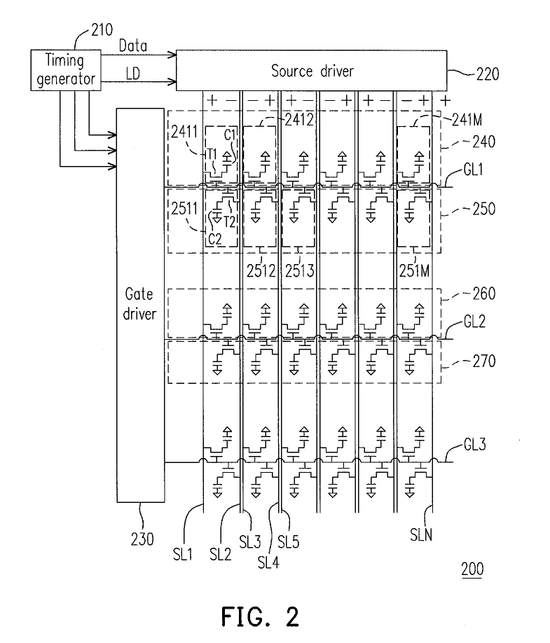

Referring to FIG. 2, FIG. 2 is a schematic diagram illustrating a display panel 200 according to an embodiment of the present invention. The display panel 200 includes a timing generator 210, a source driver 220 and a gate driver 230. Moreover, the source driver 220 is connected to a plurality of source data lines SL1-SLN, and the gate driver 230 is connected to a plurality of gate scan lines GL1, GL2 and GL3. The source data lines SL1-SLN and the gate scan lines GL1, GL2 and GL3 are mutually intersected in a chessboard-like approach, and accordingly define display rows 240 and 250, etc.

The display row 240 includes a plurality of pixel units 2411-241M, wherein each of the pixel units 2411-241M has a driving transistor T1, and N is twice the bigger to M. It is known by those skilled in the art that the driving transistor T1 has a gate, a first source/drain and a second source/drain. In the present embodiment, the driving transistor T1 in the pixel unit 2411 is taken as an example. The gate of the driving transistor T1 is coupled to the gate scan line GL1, the first source/drain of the driving transistor T1 is coupled to the source data line SL1, and the second source/drain of the driving transistor T1 is coupled to a liquid crystal capacitor C1.

The display row 250 includes a plurality of pixel units 2511-251M, wherein each of the pixel units 2511-251M also has a driving transistor T2. In the present embodiment, the driving transistor T2 in the pixel unit 2511 is taken as an example. A gate of the driving transistor T2 is coupled to the gate scan line GL1, a first source/drain of the driving transistor T2 is coupled to the source data line SL2, and a second source/drain of the driving transistor T2 is coupled to a liquid crystal capacitor C2.

Namely, the first sources/drains of the driving transistors of the display row 240 are coupled to odd columns of the source data lines, and the first sources/drains of the driving transistors of the display row 250 are coupled to even columns of the source data lines.

Moreover, the driving transistors T1 and T2 in the pixel units 2411-241M and 2511-251M are thin-film transistors, and an amount of the gate scan lines GL1-GL3 is not limited to 3. Actually, the amount of the gate scan lines relates to a size of the display panel. Here, the amount of the gate scan line is at least one.

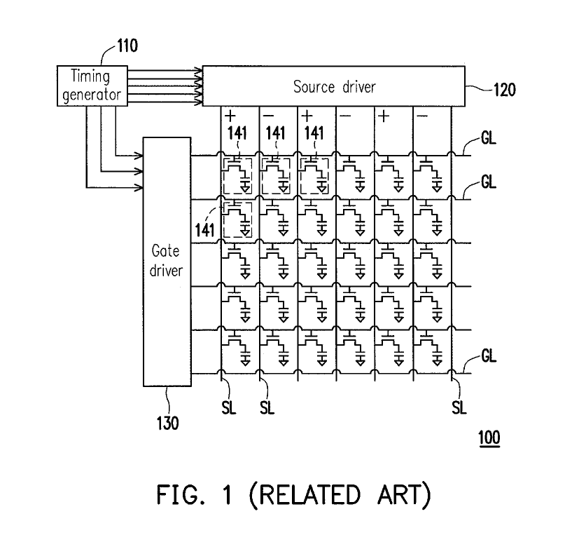

It should be noticed that in the display panel 200 of the present embodiment, gates of the driving transistors in the pixel units 2411-241M and 2511-251M of two different display rows 240 and 250 are commonly coupled to the gate scan line GL1. Therefore, the amount of the gate scan lines of the display panel 200 can be a half compared to that of the conventional display panel (shown in FIG. 1). Accordingly, when the display panel 200 performs a gate scanning, a time for scanning each of the gates is doubled, so that a charging time of the pixel unit is increased.

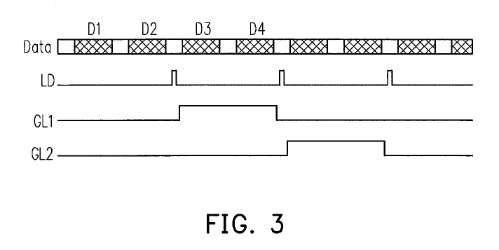

Referring to FIG. 2 and FIG. 3, FIG. 3 is a diagram of operation waveforms of the display panel 200. The timing generator 210 sequentially transmits pixel data Data to the source driver 220. Since data of the pixel units in the display rows 240 and 250 can be sequentially transmitted, the timing generator 210 sequentially transmits data D1 used for being displayed on the display row 240 and data D2 used for being displayed on the display row 250 to the source driver 220, and enables a latch signal LD after the data D1 and D2 are transmitted.

The source driver 220 latches the data D1 and D2 according to the enabled latch signal LD, and simultaneously transmits the data D1 and D2 by voltages through the source data lines SL1-SLN. After (or at the same time) the source data lines SL1-SLN simultaneously transmits the data D1 and D2 by voltages, the timing generator 210 notifies the gate driver 230 to enable the gate scan line GL1, so that the pixel units 2411-241N and 2511-251N of the display rows 240 and 250 can be simultaneously scanned and charged.

While the gate scan line GL1 is enabled, and the display rows 240 and 250 are charged, the timing generator 210 continually transmits data D3 and D4 to the source driver 220. After the timing generator 210 transmits the data D3 used for being displayed on a display row 260 and the data D4 used for being displayed on the display row 270, the timing generator 210 again enables the latch signal LD. Similarly, the source driver 220 again latches the data D3 and D4 according to the enabled latch signal LD, and simultaneously transmits the data D3 and D4 by voltages through the source data lines SL1-SLN. The timing generator 210 then notifies the gate driver 230 to enable the gate scan line GL2, so that the display rows 260 and 270 can be charged.

It should be noticed that since the latch signal LD is enabled only after the timing generator 210 transmits the pixel data of two display rows, a transition frequency of the latch signal LD used to be transited each time after the pixel data of one display row being transmitted is reduced to a half. Therefore, power consumptions of the timing generator 210 and the source driver 220 can be effectively reduced, and since the frequency of the signal transition is reduced, an internal noise of the circuit is reduced.

It should be noticed that a method for the source driver 220 simultaneously transmitting the data D1, D2, D3 and D4 by voltages through the source data lines SL1-SLN is to perform a conversion (for example, performing a gamma voltage conversion) to the data D1, D2, D3 and D4 with a digital format, and generate the voltages with an analog format, so as to perform the transmission.

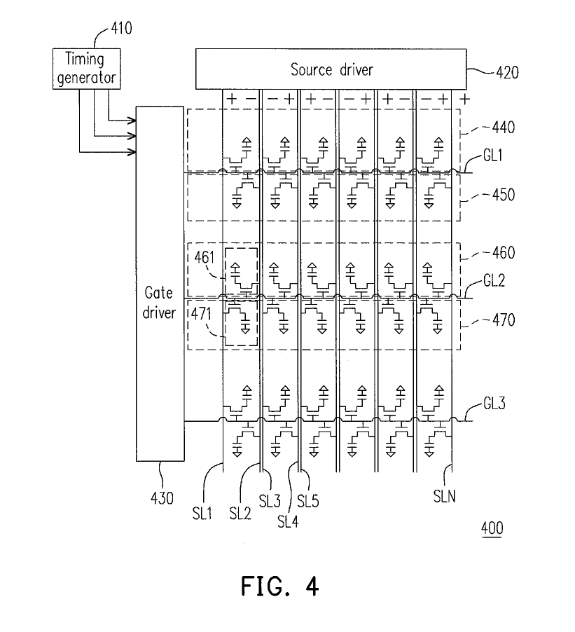

Referring to FIG. 4, FIG. 4 is a schematic diagram illustrating a display panel 400 according to an embodiment of the present invention. The display panel 400 includes a timing generator 410, a source driver 420 and a gate driver 430. The source driver 420 is connected to a plurality of the source data lines SL1-SLN, and the gate driver 430 is connected to a plurality of the gate scan lines GL1, GL2 and GL3. The source data lines SL1-SLN and the gate scan lines GL1, GL2 and GL3 are mutually intersected in a chessboard-like approach, and accordingly define display rows 460 and 470, etc.

Referring to FIG. 2 and FIG. 4, a main difference between the display panel 400 and the display panel 200 is that the a connecting method between the driving transistors of the display rows 440 and 450 and the source data lines SL1-SLN is the same to that between the driving transistors of the display rows 240-270 and the source data lines SL1-SLN, and the connecting method between the driving transistors of the display rows 460 and 470 and the source data lines SL1-SLN is different to that between the driving transistors of the display rows 240-270 and the source data lines SL1-SLN. Wherein, a first source/drain of the driving transistor in the pixel unit 461 of the display row 460 is coupled to the source data line SL2 (an even column of the source data line), and a first source/drain of the driving transistor in the pixel unit 471 of the display row 470 is coupled to the source data line SL1 (an odd column of the source data line).

Since the same source data line can only provide a pixel data voltage of one polarity, coupling variations between different pixel units and the source data lines SL1-SLN of the display panel 200 and the display panel 400 can achieve different inversion effects of the display panel (the so-called inversion refers to a dot inversion, a column inversion, or a row inversion, etc, which is known by those skilled in the art). Certainly, more different variations can be deduced according to the diagrams of FIG. 2 and FIG. 4. For example, the pixel unit 2411 of FIG. 2 is maintained to be coupled to the source data line SL1, the pixel unit 2412 is changed to be coupled to the source data line SL4, the corresponding pixel unit 2511 is maintained to be coupled to the source data line SL2, and the pixel unit 2512 is changed to be coupled to the source data line SL3.

In summary, by simultaneously performing the gate scanning to the adjacent different display rows, the amount of the gate scan lines of the display panel can be effectively reduced. Therefore, the time used for each gate scanning is correspondingly increased, which can effectively improve a display performance of the display panel. Moreover, a switching frequency of a related circuit signal (for example, the latch signal LD) corresponding to the gate scanning frequency is also reduced, which can effectively suppress generation of the noise, and effectively reduce the power consumption.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display panel, having a plurality of source data lines, a first gate scan line and a second gate scan line, comprising:
at least one first display row, and the first display row comprising:
a plurality of first pixel units, and each of the first pixel units having a first driving transistor, gates of the first driving transistors being commonly coupled to the first gate scan line, and first sources/drains of the first driving transistors being sequentially coupled to odd columns of the source data lines;
at least one second display row, and the second display row comprising:
a plurality of second pixel units, and each of the second pixel units having a second driving transistor, gates of the second driving transistors are commonly coupled to the first gate scan line, and first sources/drains of the second driving transistors are sequentially coupled to even columns of the source data lines;
at least one third display row, and the third display row comprising:
a plurality of third pixel units, and each of the third pixel units having a third driving transistor, gates of the third driving transistors being commonly coupled to a second gate scan line, and first sources/drains of the third driving transistors being sequentially coupled to even columns of the source data lines; and
at least one fourth display row, and the fourth display row comprising:
a plurality of fourth pixel units, and each of the fourth pixel units having a fourth driving transistor, gates of the fourth driving transistors being commonly coupled to the second gate scan line, and first sources/drains of the fourth driving transistors being sequentially coupled to odd columns of the source data lines,
wherein the first, the second, the third and the fourth display rows are sequentially disposed on the display panel.

2. The display panel as claimed in claim 1, wherein an amount of the source data lines is a sum of an amount of the first pixel units and an amount of the second pixel units.

3. The display panel as claimed in claim 1, wherein each of the first pixel units further comprises:
a first liquid crystal capacitor, coupled to a second source/drain of the first driving transistor.

4. The display panel as claimed in claim 1, wherein each of the second pixel units further comprises:
a second liquid crystal capacitor, coupled to a second source/drain of the second driving transistor.

5. The display panel as claimed in claim 1, wherein the first driving transistors and the second driving transistors are thin-film transistors.

6. The display panel as claimed in claim 1, wherein the third driving transistors and the fourth driving transistors are thin-film transistors.

7. The display panel as claimed in claim 1, wherein each of the first pixel units further comprises:
a third liquid crystal capacitor, coupled to a second source/drain of the third driving transistor.

8. The display panel as claimed in claim 1, wherein each of the fourth pixel units further comprises:
a fourth liquid crystal capacitor, coupled to a second source/drain of the fourth driving transistor.

9. The display panel as claimed in claim 1, further comprising:
at least one source driver, coupled to the source data lines for transmitting a plurality of pixel data through the source data lines.

10. The display panel as claimed in claim 1, further comprising:
at least one gate driver, coupled to the first gate scan line for performing a scan operation to the first and the second display row through the first gate scan line.
